(19) United States
(12) Patent Application Publication
(10) Pub. No.: US 2026/0194007 A1
(43) Pub. Date: Jul. 9, 2026

(54) INTAKE DUCT

(71) Applicant: MITSUBISHI HEAVY INDUSTRIES, LTD., Tokyo (JP)

(72) Inventors: Tomohiro GOTO, Tokyo (JP); Keizo OHNISHI, Tokyo (JP)

(21) Appl. No.: 19/436,202

(22) Filed: Dec. 30, 2025

(30) Foreign Application Priority Data
Jan. 9, 2025 (JP) 2025-003398

(51) Int. Cl. F02C 7/045

(52) U.S. Cl. CPC F02C 7/045; F05D 2240/12; F05D 2260/96

(57) ABSTRACT

An intake duct according to at least one embodiment of the present disclosure is an intake duct for guiding intake air to a compressor of a gas turbine, comprising: an outdoor duct region arranged outdoors; and an indoor duct region connected to the outdoor duct region and arranged indoors. A sound absorption coefficient of an outer surface of the intake duct in at least a part of the indoor duct region is greater than a sound absorption coefficient of the outer surface of the intake duct in the outdoor duct region.

### TECHNICAL FIELD

The present disclosure relates to an intake duct for guiding intake air to a compressor of a gas turbine.

The present application claims priority based on Japanese Patent Application No. 2025-003398 filed on January 9, 2025, the entire content of which is incorporated herein by reference.

### BACKGROUND ART

In an intake duct for guiding intake air to a compressor of a gas turbine, a sound absorbing material is provided in the intake duct to reduce the transmission of intake noise generated in the compressor to the outside (see, for example, Patent Document 1).

### Citation List

### Patent Literature

Patent Document 1: JP2014-190253A

### SUMMARY

For example, in a region where the outer surface of the intake duct faces another structure or the like, sound may reverberate between the outer surface of the intake duct and the other structure, increasing acoustic energy and potentially becoming a source of unintended noise.

In view of the above circumstances, an object of at least one embodiment of the present disclosure is to provide an intake duct capable of reducing noise.

An intake duct according to at least one embodiment of the present disclosure is an intake duct for guiding intake air to a compressor of a gas turbine, including: an outdoor duct region arranged outdoors; and an indoor duct region connected to the outdoor duct region and arranged indoors. A sound absorption coefficient of an outer surface of the intake duct in at least a part of the indoor duct region is greater than a sound absorption coefficient of the outer surface of the intake duct in the outdoor duct region.

According to at least one embodiment of the present disclosure, it is possible to reduce noise in the intake duct.

### BRIEF DESCRIPTION OF DRAWINGS

FIG. 1 is a schematic diagram illustrating a part of a gas turbine plant to which an intake duct according to some embodiments is applied.

FIG. 2 is a schematic plan cross-sectional view taken along line II-II of FIG. 1.

FIG. 3 is an enlarged view of part A in FIG. 1.

FIG. 4 is a schematic diagram of a cross-section along the thickness direction of a duct plate in an intake duct according to one embodiment.

FIG. 5 is a schematic diagram of a cross-section along the thickness direction of a duct plate in an intake duct according to another embodiment.

FIG. 6 is an overall configuration diagram of a gas turbine according to one embodiment.

### DETAILED DESCRIPTION

Embodiments of the present disclosure will be described below with reference to the accompanying drawings. It is intended, however, that unless particularly identified, dimensions, materials, shapes, relative positions, and the like of components described in the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

### Overview of Gas Turbine Plant 10

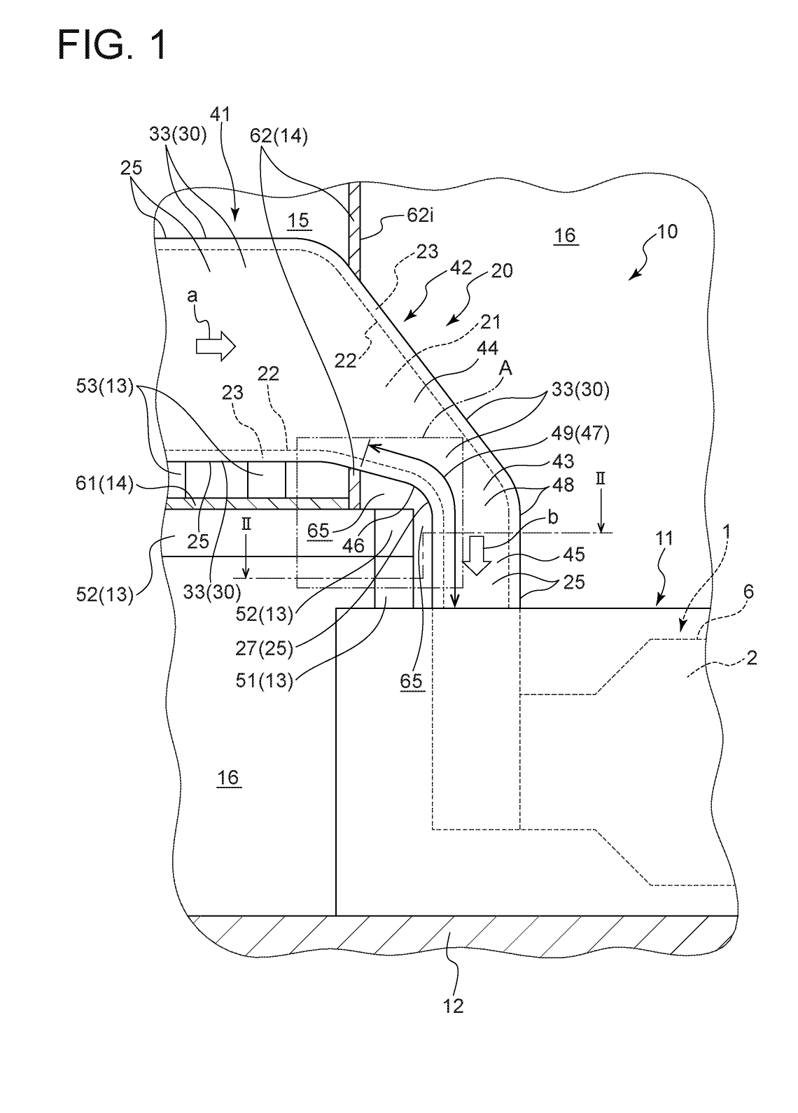

FIG. 1 is a schematic diagram illustrating a part of a gas turbine plant 10 to which an intake duct according to some embodiments is applied.

The gas turbine plant 10 according to an embodiment includes a gas turbine 1, an enclosure 11 that accommodates a casing 6 of the gas turbine 1, and an intake duct 20 for guiding intake air to a compressor 2 of the gas turbine 1.

The gas turbine plant 10 according to an embodiment includes a support structure 13 that supports the intake duct 20 at a position spaced upward from a foundation 12, and a building 14 that accommodates the enclosure 11.

The gas turbine 1 according to an embodiment is an industrial gas turbine. With the operation of the gas turbine 1, noise including intake sound, combustion sound, exhaust sound, or rotational sound is generated. Therefore, in the gas turbine plant 10 according to an embodiment, the enclosure 11 that covers the periphery of the gas turbine 1 is provided to reduce the diffusion of noise to the surroundings.

### Overview of Gas Turbine 1

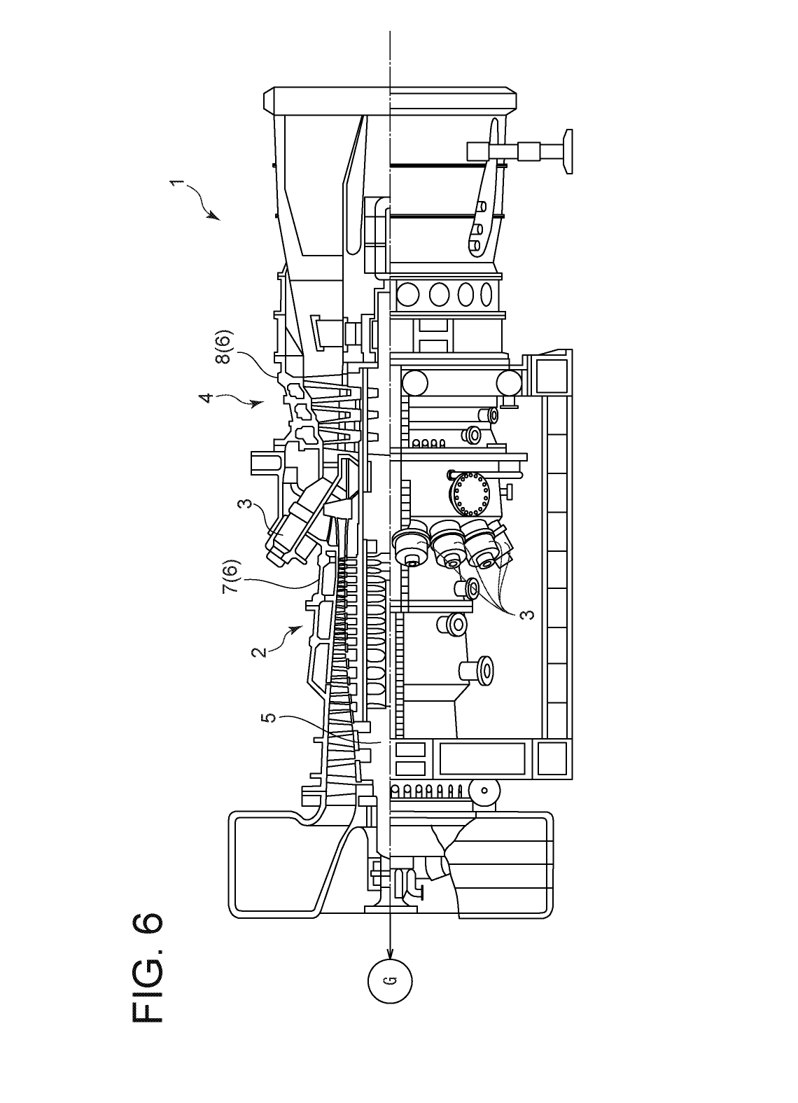

As shown in FIG. 6, the gas turbine 1 according to an embodiment includes a compressor 2, a combustor 3, and a turbine 4 and drives an external device such as a generator G. In the case of the gas turbine 1 for power generation, the generator G is connected to a rotor 5.

The compressor 2 sucks and compresses the ambient air, the atmosphere, and supplies the compressed air to one or more combustors 3.

In the gas turbine 1 according to an embodiment, the casing 6 includes a casing (compressor casing) 7 of the compressor 2 and a casing (turbine casing) 8 of the turbine 4.

The combustor 3 produces hot gas (combustion gas) by burning fuel supplied from the outside, using the air compressed by the compressor 2. In the gas turbine 1 according to an embodiment, a plurality of combustors 3 are arranged annularly around the rotor 5.

The turbine 4 receives the hot combustion gas produced by the combustor 3 to generate a rotational driving force, and outputs the generated rotational driving force to the compressor 2 and the generator G, the external device.

### Overview of Intake Duct 20

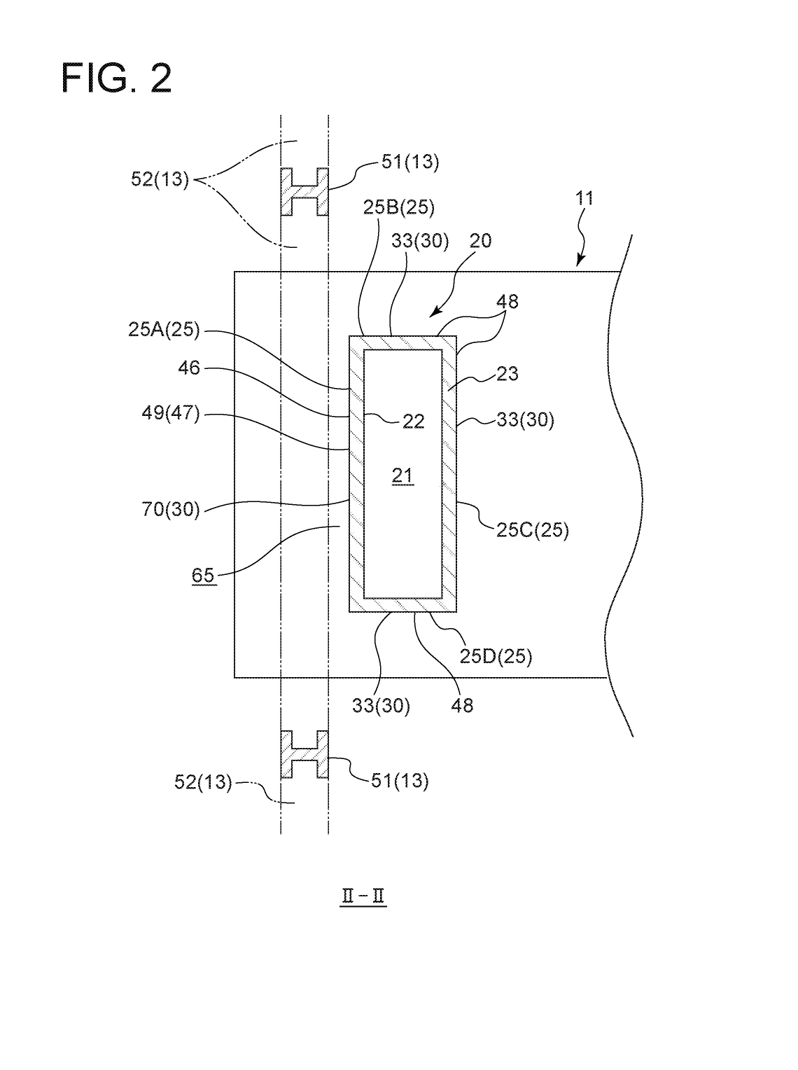

FIG. 2 is a schematic plan cross-sectional view taken along line II-II of FIG. 1.

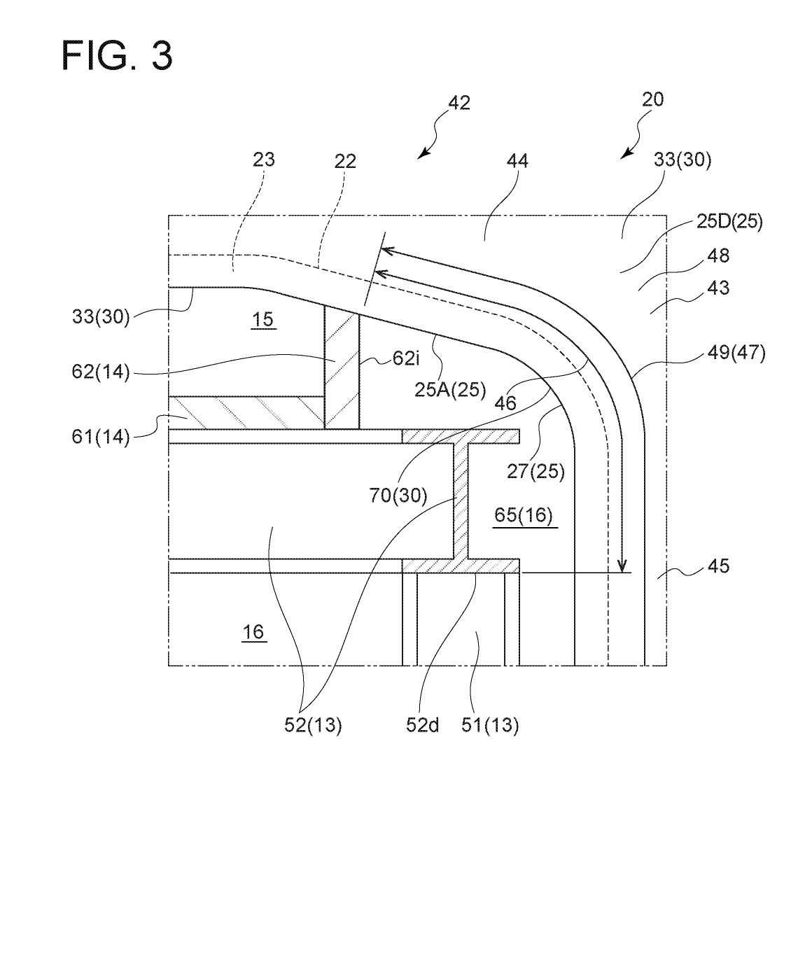

FIG. 3 is an enlarged view of part A in FIG. 1.

The intake duct 20 according to some embodiments has a duct plate 22 that constitutes a passage 21 through which air (intake air) guided to the compressor 2 flows, a sound absorbing structure 23 that includes a sound absorbing material and is provided outside the intake duct 20, that is, on the opposite side of the duct plate 22 from the passage 21 in the thickness direction of the duct plate 22, and a covering member 30 that covers the sound absorbing structure 23 from the outside of the intake duct 20.

Between the duct plate 22 and the covering member 30, there are also a reinforcing member (not shown) for reinforcing the duct plate 22, and a holding member (not shown) for holding the sound absorbing structure 23 on the duct plate 22 or the reinforcing member (not shown).

The sound absorbing structure 23 and the covering member 30 may be provided inside the intake duct 20, that is, on the passage 21 side of the duct plate 22 in the thickness direction of the duct plate 22.

The covering member 30 is, for example, a coated steel plate in an outdoor duct region 41 and a non-facing region 48, which will be described later.

The intake side of the compressor 2 communicates with an intake chamber (not shown) in the outdoors 15. Intake air taken into the intake chamber from the outside flows toward the compressor 2 through the passage 21 of the intake duct 20 as shown by white arrows a and b in FIG. 1, and is guided to the compressor 2.

In the gas turbine plant 10 according to an embodiment, the intake chamber (not shown) is arranged, for example, at a position higher than the gas turbine 1.

The intake duct 20 according to some embodiments includes an outdoor duct region 41 arranged in the outdoors 15, and an indoor duct region 42 connected to the outdoor duct region 41 and arranged in the indoors 16, which is inside the building 14.

The outdoor duct region 41 is supported, for example, via struts 53 by beams 52 of the support structure 13, which are supported by columns 51 of the support structure 13.

Although not shown in FIG. 1, the generator G is arranged below the beams 52 that support the outdoor duct region 41. The upper part of the beams 52 is covered by a part of a ceiling 61 of the building 14. That is, the columns 51 and the beams 52 of the support structure 13 are also part of the structure of the building 14. The beams 52 include the beams 52 extending in the left-right direction in FIG. 1 and FIG. 3, and the beams 52 extending in the depth direction of the paper in FIG. 1 and FIG. 3, which are indicated by dashed-two dotted lines in FIG. 2.

The intake duct 20 according to some embodiments penetrates a wall 62 of the building 14. Therefore, the outdoor duct region 41 is a region of the intake duct 20 on the outdoor 15 side of the wall 62 of the building 14, and the indoor duct region 42 is a region of the intake duct 20 on the indoor 16 side of the wall 62 of the building 14.

In the intake duct 20 according to some embodiments, the indoor duct region 42 has a curved portion 43 where the indoor duct region 42 is curved along the extending direction of the indoor duct region 42. In the intake duct 20 according to some embodiments, the curved portion 43 exists between a region 44 extending obliquely downward toward the downstream side in the flow direction of intake air in the indoor duct region 42, and a region 45 extending vertically on the downstream side in the flow direction of intake air from the region 44.

### Reverberant Sound between Outer Surface 25 of Intake Duct 20 and Other Structures

For example, in a region where the outer surface 25 of the intake duct 20 faces another structure or the like at a relatively short distance, sound may reverberate between the outer surface 25 of the intake duct 20 and the other structure, increasing acoustic energy and potentially becoming a source of unintended noise.

Therefore, the intake duct 20 according to some embodiments is configured such that the sound absorption coefficient α2 of the outer surface 25 of the intake duct 20 in at least a part of the indoor duct region 42 is greater than the sound absorption coefficient α1 of the outer surface 25 of the intake duct 20 in the outdoor duct region 41.

The sound absorption coefficient α (sound absorption coefficient α1 and sound absorption coefficient α2) of the outer surface 25 of the intake duct 20 is the sound absorption coefficient of the intake duct 20 for sound from the outside of the intake duct 20, that is, from the side opposite to the passage 21 in the thickness direction of the duct plate 22. That is, the sound absorption coefficient α (sound absorption coefficient α1 and sound absorption coefficient α2) of the outer surface 25 of the intake duct 20 is the sound absorption coefficient on the outer surface 25 side of the intake duct 20.

The sound absorption coefficient α1 and the sound absorption coefficient α2 are, for example, sound absorption coefficients measured by a measurement method according to JIS A 1405-1 or JIS A 1405-2.

The configuration for making the sound absorption coefficient α2 greater than the sound absorption coefficient α1 will be described later.

Generally, sound is more likely to be muffled in the indoors 16 compared to the outdoors 15. Therefore, noise in the indoors 16 is perceived as louder compared to the outdoors 15.

With the intake duct 20 according to some embodiments, since the sound absorption coefficient α2 of the outer surface 25 of the intake duct 20 in at least a part of the indoor duct region 42 is greater than the sound absorption coefficient α1 of the outer surface 25 of the intake duct 20 in the outdoor duct region 41, noise is more likely to be absorbed in the indoor duct region 42, and noise in the indoors 16 can be reduced.

In the intake duct 20 according to some embodiments, the sound absorption coefficient α2 of the outer surface 25 of the intake duct 20 in at least a part of a facing region 46 facing a structure or a foundation within the indoor duct region 42 is greater than the sound absorption coefficient α1 of the outer surface 25 of the intake duct 20 in the outdoor duct region 41.

This reduces noise generated by sound reverberating between the outer surface 25 of the intake duct 20 in the indoor duct region 42 and another structure or foundation, thereby reducing noise in the indoors 16.

The facing region 46 is a region facing a narrow part 65, which is a space in the indoors 16 where the outer surface 25 of the intake duct 20 and another structure or the like face each other at a relatively short distance.

Here, the above-described structure or foundation includes a member constituting the building 14 in which the indoor duct region 42 is accommodated, or the enclosure 11 in which the casing 6 of the gas turbine 1 is accommodated. The member constituting the building 14 includes, for example, the columns 51 and the beams 52, which are the support structure 13, and the ceiling 61 and the wall 62 of the building 14.

This reduces noise generated by sound reverberating between the outer surface 25 of the intake duct 20 in the indoor duct region 42 and the member constituting the building 14 in which the indoor duct region 42 is accommodated, or the enclosure 11 in which the casing 6 of the gas turbine 1 is accommodated.

For example, in the example shown in FIGS. 1 to 3, the facing region 46 is a region facing the wall 62 and the beams 52 included in part A of FIG. 1. As shown in FIG. 2, the columns 51 appearing in FIGS. 1 to 3 do not face the indoor duct region 42. Therefore, in the example shown in FIGS. 1 to 3, the facing region 46 is a region from an inner surface 62i of the wall 62 of the building 14 to a lower end 52d of the beams 52 extending in the depth direction of the paper in FIGS. 1 to 3, as shown in FIG. 3.

A region other than the facing region 46 on the outer surface 25 of the indoor duct region 42 is also referred to as a non-facing region 48.

Further, as clearly shown in FIG. 2, the intake duct 20 has a passage 21 with a rectangular shape when viewed from the flow direction of intake air, and the outer surface 25 similarly has a rectangular shape when viewed from the flow direction of intake air. That is, the outer surface 25 includes four surfaces when viewed from the flow direction of intake air. For convenience of description, among these four surfaces, the surface located on the left side of the passage 21 in FIG. 2 will be referred to as a first surface 25A, and hereinafter, clockwise in FIG. 2, also referred to as a second surface 25B, a third surface 25C, and a fourth surface 25D.

Among these four surfaces 25A, 25B, 25C, and 25D, the surface facing the wall 62 and the beams 52 included in part A of FIG. 1 is the first surface 25A. Therefore, the facing region 46 exists on the first surface 25A.

The second surface 25B, the third surface 25C, and the fourth surface 25D are non-facing regions 48.

The sound absorption coefficient α3 of the outer surface 25 of the non-facing region 48 may be greater than the sound absorption coefficient α2 of the outer surface 25 in at least a part of the facing region 46, or may be the same as the sound absorption coefficient α1 of the outer surface 25 in the outdoor duct region 41.

The sound absorption coefficient α2 of the outer surface 25 may be greater than the sound absorption coefficient α1 of the outer surface 25 of the intake duct 20 in the outdoor duct region 41 over the entire facing region 46.

Further, in the example shown in FIGS. 1 to 3, in a region 47 on the first surface 25A from the inner surface 62i of the wall 62 of the building 14 to the enclosure 11, the sound absorption coefficient α2 of the outer surface 25 of the intake duct 20 may be greater than the sound absorption coefficient α1 of the outer surface 25 of the intake duct 20 in the outdoor duct region 41.

The intake duct 20 according to some embodiments has, on the outer surface 25 of the curved portion 43, a radially inner outer surface 27 centered on the center of curvature of the curve. The sound absorption coefficient α2 of the outer surface 27 in at least a part of the region facing the structure or foundation is greater than the sound absorption coefficient α1 of the outer surface 25 of the intake duct 20 in the outdoor duct region 41.

The outer surface 27 in the curved portion 43 is the outer surface 25 included in the first surface 25A.

The outer surface 27 in the curved portion 43 is arranged so as to surround the structure or the like facing the outer surface 27, and thus noise is more likely to reverberate between the outer surface 27 and the structure or the like compared to the outer surfaces 25 other than the outer surface 27.

With the intake duct 20 according to some embodiments, even when noise is likely to reverberate due to the shape of the indoor duct region 42, noise generated by sound reverberating between the intake duct 20 and the structure or the like can be effectively reduced.

### Configuration for Making Sound Absorption Coefficient α2 Greater than Sound Absorption Coefficient α1

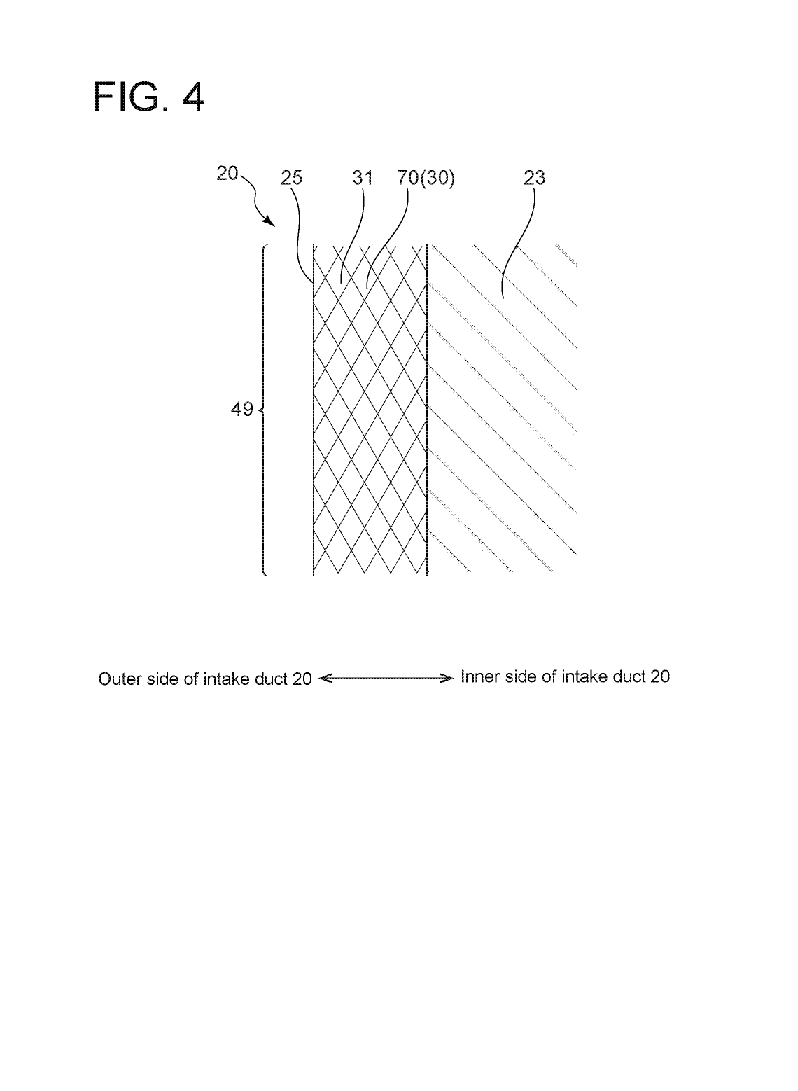

FIG. 4 is a schematic diagram of a cross-section along the thickness direction of the duct plate 22 in the intake duct 20 according to one embodiment, showing a cross-section in the vicinity of the outer surface 25 in a high sound absorption region 49, which will be described later.

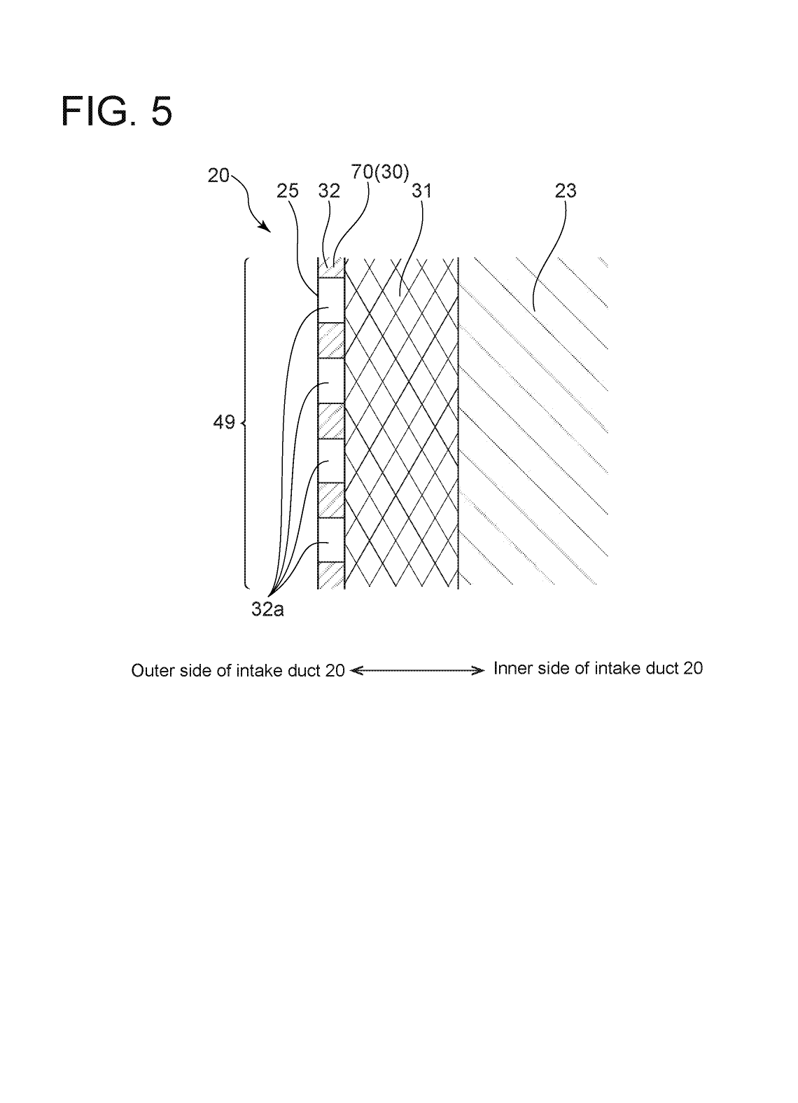

FIG. 5 is a schematic diagram of a cross-section along the thickness direction of the duct plate 22 in the intake duct 20 according to another embodiment, showing a cross-section in the vicinity of the outer surface 25 in the high sound absorption region 49.

In the intake duct 20 according to some embodiments, in the indoor duct region 42, the high sound absorption region 49, which is a region having a sound absorption coefficient α2 greater than the sound absorption coefficient α1 of the outer surface 25 of the intake duct 20 in the outdoor duct region 41, is covered with an air-permeable member 70 on the outer surface 25 of the intake duct 20. That is, the covering member 30 in the high sound absorption region 49 is the air-permeable member 70.

This makes it difficult for sound from the outside of the intake duct 20, that is, from the side opposite to the passage 21 in the thickness direction of the duct plate 22, to be reflected by the surface (outer surface 25) of the member 70. Therefore, while protecting the sound absorbing material or the like of the sound absorbing structure 23 arranged inward of the member 70 in the intake duct 20, that is, on the passage 21 side of the duct plate 22 in the thickness direction of the duct plate 22, noise generated by sound reverberating between the high sound absorption region 49 and the structure or the like can be effectively reduced.

As described above, in the outdoor duct region 41 and the non-facing region 48, the covering member 30 is, for example, a coated steel plate.

As shown in FIG. 4, in the intake duct 20 according to an embodiment, the high sound absorption region 49 is covered with a woven fabric 31 on the outer surface 25 of the intake duct 20. Examples of the woven fabric 31 include glass cloth.

This effectively reduces noise generated by sound reverberating between the intake duct 20 and the structure or the like, while protecting the sound absorbing structure 23 arranged inward of the woven fabric 31 in the intake duct 20.

As shown in FIG. 5, in the intake duct 20 according to another embodiment, the high sound absorption region 49 is covered with a perforated plate 32 having a multitude of through holes 32a penetrating in the plate thickness direction on the outer surface 25 of the intake duct 20.

This effectively reduces noise generated by sound reverberating between the intake duct 20 and the structure or the like, while protecting the sound absorbing structure 23 arranged inward of the perforated plate 32 in the intake duct 20.

As shown in FIG. 5, the woven fabric 31 may be provided between the perforated plate 32 and the sound absorbing structure 23.

In the intake duct 20 according to some embodiments, as described above, the outdoor duct region 41 is covered with a coated steel plate, which is a non-air-permeable member 33, on the outer surface 25 of the intake duct 20.

This protects the sound absorbing structure 23 arranged inward of the member 33 in the intake duct 20 in the outdoors 15 from wind, rain, and the like.

The present disclosure is not limited to the embodiments described above, but includes modifications to the embodiments described above, and embodiments composed of combinations of those embodiments.

The contents described in the above embodiments would be understood as follows, for instance.

(1) An intake duct 20 according to at least an embodiment of the present disclosure is an intake duct 20 for guiding intake air to a compressor 2 of a gas turbine 1, including: an outdoor duct region 41 arranged in the outdoors 15; and an indoor duct region 42 connected to the outdoor duct region 41 and arranged in the indoors 16. A sound absorption coefficient α2 of an outer surface 25 of the intake duct 20 in at least a part of the indoor duct region 42 is greater than a sound absorption coefficient α1 of the outer surface 25 of the intake duct 20 in the outdoor duct region 41.

Generally, sound is more likely to be muffled in the indoors 16 compared to the outdoors 15. Therefore, noise in the indoors 16 is perceived as louder compared to the outdoors 15.

With the above configuration (1), since the sound absorption coefficient α2 of the outer surface 25 of the intake duct 20 in at least a part of the indoor duct region 42 is greater than the sound absorption coefficient α1 of the outer surface 25 of the intake duct 20 in the outdoor duct region 41, noise is more likely to be absorbed in the indoor duct region 42, and noise in the indoors 16 can be reduced.

(2) In some embodiments, in the above configuration (1), a sound absorption coefficient α2 of the outer surface 25 of the intake duct 20 in at least a part of a region (facing region 46) facing a structure (column 51, beam 52, ceiling 61, wall 62) or a foundation 12 within the indoor duct region 42 may be greater than the sound absorption coefficient α1 of the outer surface 25 of the intake duct 20 in the outdoor duct region 41.

With the above configuration (2), noise generated by sound reverberating between the outer surface 25 of the intake duct 20 in the indoor duct region 42 and another structure or foundation can be reduced, thereby reducing noise in the indoors 16.

(3) In some embodiments, in the above configuration (2), the structure may be a member (column 51, beam 52, ceiling 61, wall 62) constituting a building 14 in which the indoor duct region 42 is accommodated, or an enclosure 11 in which a casing 6 of the gas turbine 1 is accommodated.

With the above configuration (3), noise generated by sound reverberating between the outer surface 25 of the intake duct 20 in the indoor duct region 42 and the member (column 51, beam 52, ceiling 61, wall 62) constituting the building 14 in which the indoor duct region 42 is accommodated, or the enclosure 11 in which the casing 6 of the gas turbine 1 is accommodated, can be reduced.

(4) In some embodiments, in the above configuration (2) or (3), the indoor duct region 42 may have a curved portion 43 where the indoor duct region 42 is curved along an extending direction of the indoor duct region 42. A sound absorption coefficient α2 of the outer surface 25 of the intake duct 20 in at least a part of a region (facing region 46), which is a radially inner outer surface 27 of the outer surface 25 of the curved portion 43 centered on a center of curvature of the curve and faces the structure (column 51, beam 52, ceiling 61, wall 62) or the foundation 12, may be greater than the sound absorption coefficient α1 of the outer surface 25 of the intake duct 20 in the outdoor duct region 41.

The radially inner outer surface 27 in the curved portion 43 is arranged so as to surround the structure or the like facing the outer surface 27, and thus noise is more likely to reverberate between the outer surface 27 and the structure or the like compared to the outer surfaces 25 other than the outer surface 27.

With the above configuration (4), even when noise is likely to reverberate due to the shape of the indoor duct region 42, noise generated by sound reverberating between the intake duct 20 and the structure or the like can be effectively reduced.

(5) In some embodiments, in any one of the above configurations (1) to (4), in the indoor duct region 42, a region (high sound absorption region 49) having a sound absorption coefficient α2 greater than the sound absorption coefficient α1 of the outer surface 25 of the intake duct 20 in the outdoor duct region 41 may be covered with an air-permeable member 70 on the outer surface 25 of the intake duct 20.

With the above configuration (5), sound from the outside of the intake duct 20 is less likely to be reflected by the surface (outer surface 25) of the member 70. Therefore, while protecting the sound absorbing material or the like (sound absorbing structure 23) arranged inward of the member 70, noise generated by sound reverberating between the region (high sound absorption region 49) and the structure or the like can be effectively reduced.

(6) In some embodiments, in the above configuration (5), in the indoor duct region 42, the region (high sound absorption region 49) having a sound absorption coefficient α2 greater than the sound absorption coefficient α1 of the outer surface 25 of the intake duct 20 in the outdoor duct region 41 may be covered with a perforated plate 32 on the outer surface 25 of the intake duct 20.

With the above configuration (6), while protecting the sound absorbing material or the like (sound absorbing structure 23) arranged inward of the perforated plate 32, noise generated by sound reverberating between the intake duct 20 and the structure or the like can be effectively reduced.

(7) In some embodiments, in the above configuration (5), in the indoor duct region 42, the region (high sound absorption region 49) having a sound absorption coefficient α2 greater than the sound absorption coefficient α1 of the outer surface 25 of the intake duct 20 in the outdoor duct region 41 may be covered with a woven fabric 31 on the outer surface 25 of the intake duct 20.

With the above configuration (7), while protecting the sound absorbing material or the like (sound absorbing structure 23) arranged inward of the woven fabric 31, noise generated by sound reverberating between the intake duct 20 and the structure or the like can be effectively reduced.

(8) In some embodiments, in any of the above configurations (5) to (7), the outdoor duct region 41 may be covered with a non-air-permeable member 33 on the outer surface 25 of the intake duct 20.

With the above configuration (8), the sound absorbing material or the like (sound absorbing structure 23) arranged inward of the member 33 in the outdoors 15 can be protected from wind, rain, and the like.

What is claimed is:

1. An intake duct for guiding intake air to a compressor of a gas turbine, comprising:
an outdoor duct region arranged outdoors; and
an indoor duct region connected to the outdoor duct region and arranged indoors,
wherein a sound absorption coefficient of an outer surface of the intake duct in at least a part of the indoor duct region is greater than a sound absorption coefficient of the outer surface of the intake duct in the outdoor duct region.

2. The intake duct according to claim 1,
wherein a sound absorption coefficient of the outer surface of the intake duct in at least a part of a region facing a structure or a foundation within the indoor duct region is greater than the sound absorption coefficient of the outer surface of the intake duct in the outdoor duct region.

3. The intake duct according to claim 2,
wherein the structure is a member constituting a building in which the indoor duct region is accommodated, or an enclosure in which a casing of the gas turbine is accommodated.

4. The intake duct according to claim 2,
wherein the indoor duct region has a curved portion where the indoor duct region is curved along an extending direction of the indoor duct region, and
wherein a sound absorption coefficient of the outer surface of the intake duct in at least a part of a region, which is a radially inner outer surface of the curved portion centered on a center of curvature of the curve and faces the structure or the foundation, is greater than the sound absorption coefficient of the outer surface of the intake duct in the outdoor duct region.

5. The intake duct according to claim 1,
wherein in the indoor duct region, a region having a sound absorption coefficient greater than the sound absorption coefficient of the outer surface of the intake duct in the outdoor duct region is covered with an air-permeable member on the outer surface of the intake duct.

6. The intake duct according to claim 5,
wherein in the indoor duct region, the region having a sound absorption coefficient greater than the sound absorption coefficient of the outer surface of the intake duct in the outdoor duct region is covered with a perforated plate on the outer surface of the intake duct.

7. The intake duct according to claim 5,
wherein in the indoor duct region, the region having a sound absorption coefficient greater than the sound absorption coefficient of the outer surface of the intake duct in the outdoor duct region is covered with a woven fabric on the outer surface of the intake duct.

8. The intake duct according to claim 5,
wherein the outdoor duct region is covered with a non-air-permeable member on the outer surface of the intake duct.
